(19) United States
(12) Patent Application Publication
(10) Pub. No.: US 2012/0173478 A1
(43) Pub. Date: Jul. 5, 2012

(54) CUSTOM DATA MART CREATION

(75) Inventors: BRETT FREDERICK JENSEN, Liberty, MO (US); JODY GOSCH, Liberty, MO (US); JOHN VITALE, Kansas City, MO (US); RAYMOND SCHARTZ, Independence, MO (US); RUSSELL PARKS, Overland Park, KS (US); CHARLES HARRISON, Kansas City, MO (US)

(73) Assignee: CERNER INNOVATION, INC., Overland Park, KS (US)

(21) Appl. No.: 12/982,233

(22) Filed: Dec. 30, 2010

(51) Int. Cl. G06F 17/30

(52) U.S. Cl. 707/602; 707/E17.005

(57) ABSTRACT

Systems, methods, and computer-readable media for creating custom data marts are provided. A selection of at least one table from a data source stored within a data warehouse is received. A selection of at least one column from the at least one table is received. Joins are created based on the selections, metadata is created and stored, and physical schema is generated to store the data mart data. The custom data mart fact table is populated with data from the selected columns. Facilities are provided for the end-user to create an abstraction layer for business intelligence reporting needs.

### BACKGROUND

The advent of powerful servers, large-scale data storage and other information infrastructure has spurred the development of advanced data warehousing and data mining applications. Structured query language (SQL) engines, on-line analytical processing (OLAP) databases and inexpensive large disk arrays have for instance been harnessed in financial, scientific, medical, and other fields to capture and analyze vast streams of transactional, experimental, and other data. The mining of that data can reveal sales trends, weather patterns, disease epidemiology and other patterns not evident from more limited or smaller-scale analysis.

In the case of medical data management, the task of receiving, conditioning, and analyzing large quantities of clinical information is particularly challenging. The sources of medical data for an organization, for instance, may include various hospitals, laboratories, research or other facilities, each of which may generate data records at different times and in widely varying formats. Those various data records may be presorted or pre-processed to include different relationships between different fields of that data, based upon different assumptions or database requirements. When received in a large-scale data warehouse, the aggregation of all such differing data points may be difficult to store in a physically or logically consistent structure. Data records may, for instance, contain different numbers or types of fields, which may have to be conformed to a standard format for warehousing and searching.

Even when conditioned and stored, that aggregation of data may prove difficult to analyze or mine for the most clinically relevant or other data, such as those indicating a disease outbreak or adverse reactions to drugs or other treatments. Clinical systems are often extremely large, with a high volume of data, and reporting that is necessary to meet business requirements is inefficient. That is in part because querying the various data sources and running the desired reports requires significant processing overhead. This heavy back-end processing is time-consuming and particularly burdensome to the server and network infrastructure. Organizations are forced to rely on pre-built business intelligence content. These out-of-the-box data marts, or fact tables, are generic and of limited value. Knowledge of the underlying structure of the data is necessary to build useful data marts that could alleviate the strain on the overall infrastructure. Other challenges in receiving, storing, and analyzing large-scale medical and other data exist.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to systems, methods, and computer-readable media for, among other things, creating custom data marts. In one embodiment, the method includes receiving a selection of a first table from a data source stored within a data warehouse. A selection of at least one column from the first table is received. The method further includes receiving a selection of a second table from a data source stored within the data warehouse. A selection of at least one column from the second table is received. Joins are created based on the selection of tables and columns and a custom data mart fact table is populated with data from the selected columns.

In another embodiment of the present invention, a graphical user interface (GUI) is stored on one or more computer-readable media and executable by a computing device. The GUI comprises a first display area configured for receiving a selection of at least one table associated with the health care related data stored in a data warehouse. A second display area is configured for receiving a selection of at least one column stored within the at least one table. A third display area is configured for displaying a list of selected columns associated with a custom data mart fact table. The GUI further comprises a fourth display area configured for receiving user-defined criteria for generating a report derived from the custom data mart.

In yet another embodiment of the present invention, a computerized system for facilitating the creation of custom data marts comprises at least one device transmitting health care related data to a server comprising at least one component. A table selection component receives a selection of a table associated with health care related data stored in a data warehouse. A column selection component receives a selection of a column associated with the selected table. A join component creates joins based on the selection of tables and columns. A population component populates the custom data mart fact table with data from the selected columns.

### BRIEF DESCRIPTION OF THE DRAWINGS

The present invention is described in detail below with reference to the attached drawings figures, wherein:

FIG. 1 is a block diagram of an exemplary computing system suitable for use in implementing embodiments of the present invention;

FIG. 2 schematically shows a network environment suitable for performing embodiments of the invention;

FIG. 3 is a flow diagram showing a method for populating a custom data mart fact table, in accordance with an embodiment of the present invention;

FIG. 4 is an illustrative screen display showing a selection of a data source, in accordance with an embodiment of the present invention; and

FIG. 5 is an illustrative screen display showing a selection of columns for building the custom data mart fact table, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention can empower an organization's ability to harness pertinent data from within the data warehouse to create functional data marts and business intelligence reporting efficiently and with limited knowledge of the underlying data structure. Embodiments present advantages over other systems which are limited to reporting against generic business intelligence content by enabling users to create custom data marts corresponding to an organizational unit's business requirements.

Data mart dimension tables refer to tables that contain data from reference tables. Reference tables typically contain an enumerated set of possible values for a certain data type. For example, a field called ‘patient condition’ may have a predefined set of values such as “good”, “fair”, “serious”, or “critical”. These values are stored in the reference tables. The dimension tables have a single-field primary key. The primary key is typically a surrogate key and is often an identify column consisting of an automatically incrementing number. Other fields, called attributes, contain the full descriptions of the dimension record. However, these fields do not contain IDs that link to other tables. Dimension tables not only provide descriptive information about activity data, but can also be used to filter or group activity data in meaningful ways.

Data mart fact tables refer to tables that contain data from activity tables. The fact tables have foreign keys to dimension tables and potentially foreign keys to other fact tables. These fields are typically integer or float values. Fact tables may also contain aggregate fields (e.g., sums, counts, averages of data). Fact tables are created to store business use data to facilitate reporting to answer functional questions.

A data mart refers to a subset of an organizational data store, typically oriented to a specific purpose or major data subject, distributed to support business needs. Data marts are analytical data stores designed to focus on specific business functions for a specific community within an organization. Data marts are often derived from subsets of data in a data warehouse.

A star schema refers to the simplest style of data warehouse schema. The star schema consists of a few fact tables (in some instances, only one) referencing any number of dimension tables.

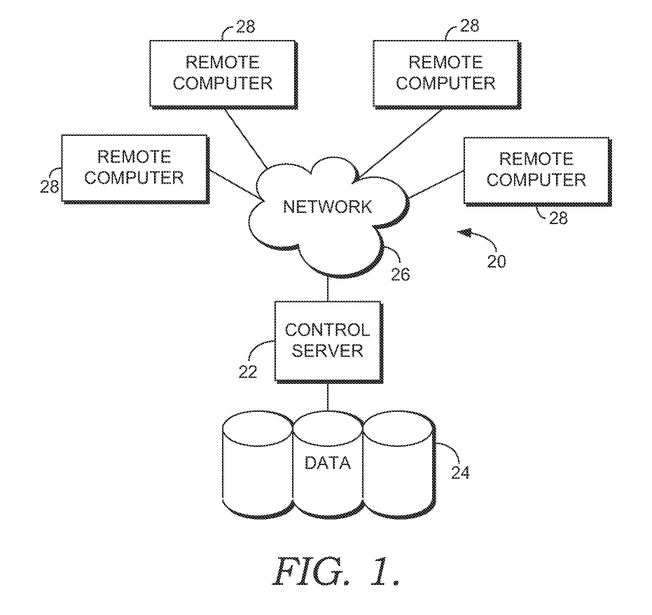

Having briefly described embodiments of the present invention, an exemplary operating environment suitable for use in implementing embodiments of the present invention is described below. Referring to FIG. 1 an exemplary computing environment with which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. Embodiments of the present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary computing environment 20 includes a general purpose computing device in the form of a server 22. Components of the server 22 may include, without limitation, a processing unit, internal system memory, and a suitable system bus for coupling various system components, including database cluster 24, with the server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 22 typically includes, or has access to, a variety of computer readable media, for instance, database cluster 24. Computer readable media can be any available media that may be accessed by server 22, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for the server 22.

The server 22 may operate in a computer network 26 using logical connections to one or more remote computers 28. Remote computers 28 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the components described above in relation to the server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the server 22 may include a modem or other means for establishing communications over the WAN, such as the Internet. In a networked environment, program modules or portions thereof may be stored in the server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., server 22 and remote computers 28) may be utilized.

In operation, a user may enter commands and information into the server 22 or convey the commands and information to the server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 22. In addition to a monitor, the server 22 and/or remote computers 28 may include other peripheral output devices, such as speakers and a printer.

Although many other internal components of the server 22 and the remote computers 28 are not shown, those of ordinary skill in the art will appreciate that such components and their interconnections are well known. Accordingly, additional details concerning the internal construction of the server 22 and the remote computers 28 are not further disclosed herein.

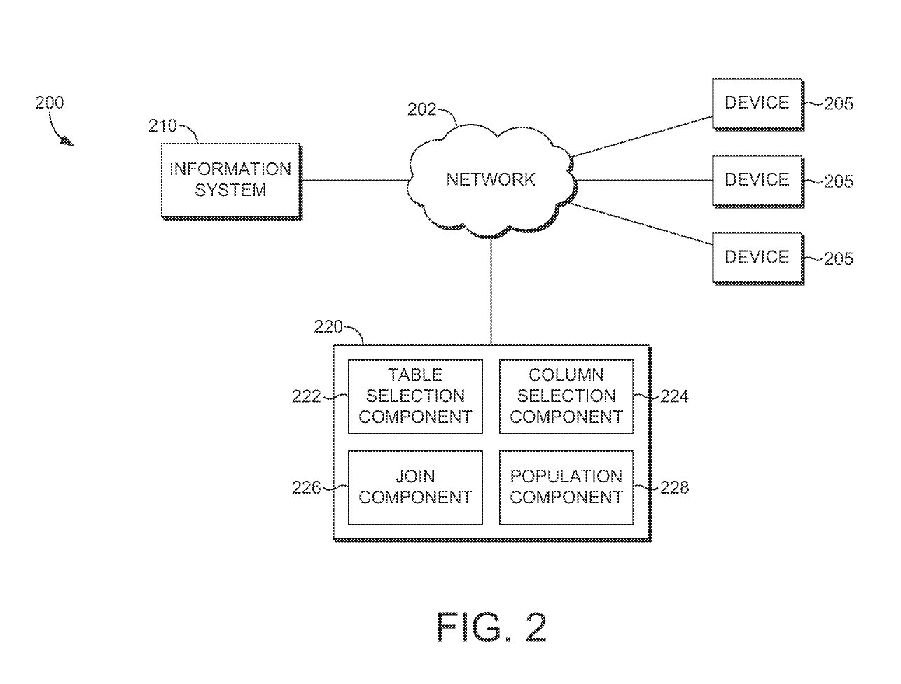

Referring now to FIG. 2, a block diagram is provided illustrating an exemplary system 200 in which a custom data mart engine 220 is shown interfaced with an information system 210 in accordance with an embodiment of the present invention. The information system 210 may be a comprehensive computing system within a clinical environment similar to the exemplary computing system 20 discussed above with reference to FIG. 1.

The information system 210 may include a database (not shown) storing data collected by the information system 210, such as from the various devices 205 connected to the system. The information system 210 may be connected via the network to a database, similarly storing data collected by the information system 210. A data warehouse stores all the data from all data sources for the organization, whether within the information system 210 or external to the information system 210. The data is received from a variety of sites within the organization and comprises many data elements. These data elements are needed for reporting and include, in various embodiments, activity data, dimension data, or aggregation data (e.g., counts and sums).

The custom data mart engine 220 is generally configured to allow users to identify data that is pertinent to their site. The data is typically a subset of the data that is organized for a specific purpose, such as reporting. Various groups or units within the organization can create custom data marts to focus on specific business functions or needs. Reporting can be accomplished with a star schema, rather than pulling data from multiple tables, and significantly reduce the time required to run reports. As shown in FIG. 2, the custom data mart engine includes a table selection component 222, a column selection component 224, a join component 226, and a population component 228. In various embodiments, the custom data mart engine 220 also includes a scheduling component (not shown), a schema component (not shown), a business intelligence component (not shown), and reporting component (not shown).

The table selection component 222 allows a user to select the various tables stored in the data warehouse that may be used to build the custom data mart. In one embodiment, the user is able to search for a table name or a table description. The user may select a table, in various embodiments, by double-clicking the table name, double-clicking the description, or dragging the table into a selected table display area. A list of parent and child tables is populated for each selected table to allow a user to navigate into and select related tables. In various embodiments, the tables are created based on clean tables, existing data mart fact tables, or a combination thereof.

After a table is selected, the column selection component 224 lists all the columns associated with the selected table. Various attributes of the columns are displayed as well, such as data type, size, and description. These attributes allow the user to quickly identify desired columns, for selection by the column selection component 224. Once the user identifies columns of particular interest, the user may drag the columns into a data mart display area. The data mart display area identifies the source table and the source column to be used in the creation of the custom data mart fact table. As can be appreciated, any number of columns or tables may be selected while creating the custom data mart fact table.

The join component 226 automatically performs all the necessary backend processing to build the custom data mart. In particular, the join component creates joins for any columns relating to reference data to the appropriate data mart dimension tables. In addition to dimension joins, the join component may be used to combine the information from one or more activity or fact tables into the data mart fact table. Thus, the join component enables a user to build a custom data mart with the necessary relationships, without requiring the user to have an understanding of the underlying data structure. In one embodiment, the join component applies the concepts of graph theory to identify appropriate joins to use when joining multiple non-adjacent tables. After the columns have been added, a schema component (not shown), in one embodiment, creates a schema based on the selected tables and columns and communicates the metadata for the new table to the metadata tables. In one embodiment, the schema is a star schema. The star schema consists of one or more fact tables. Each fact table may reference any number of dimension tables. The star schema significantly reduces overhead for queries because the join component only has to create joins for a fact table and one level of dimension tables. The identified joins required to create the data mart will be logged into the metadata tables and are used to create the load procedure for loading data into the new data mart fact table.

Once the metadata, physical schema, table definitions, load process definitions, data lineage, and the like has been communicated to the metadata tables, the population component 228 creates a load process that populates the newly created table (i.e., the custom data mart fact table) with the data identified by the source tables and columns. Writing the source table and columns to schema allows regeneration by the population component. The load process uses the newly created metadata to traverse the source system database to join and retrieve the required data. In addition to creating the schema, this process will create other database objects such as indexes, constraints, primary, alternate, and foreign keys, and the like, in order to aid in performance and maintainability. The custom data mart, in one embodiment, is accessible via the network by the devices 205 and the data mart engine 220. In this embodiment, the population component 228 populates the custom data mart via the network. In another embodiment, the custom data mart is stored within the data mart engine 220.

In one embodiment, a scheduling component (not shown) allows a user to schedule the population of the custom data mart via the population component 228. This may be desirable to avoid heavy processing during business or peak hours. In another embodiment, the population component populates the custom data mart with historical data. In another embodiment, the data is updated periodically with fresh data at user-defined intervals. In another embodiment, a business intelligence component (not shown) creates an abstraction layer. The abstraction layer is a business intelligence semantic layer that facilitates the generation of reports. In particular, the business intelligence component creates a simple Business Objects universe, containing only the fact table and associated dimensions. In addition, the abstraction layer enables the desired report to query only the newly created custom data mart, rather than sort through the entire data warehouse searching for the desired data elements.

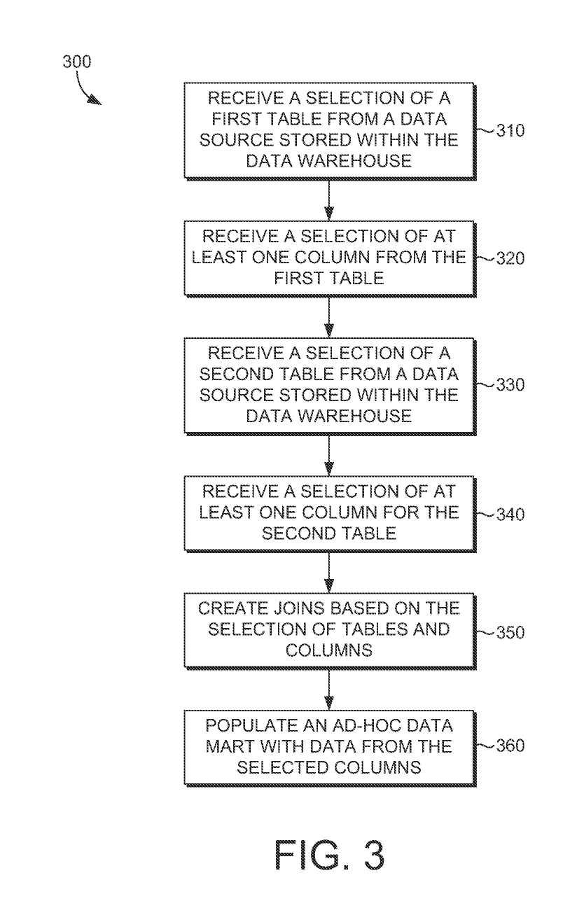

With reference to FIG. 3, an exemplary flow diagram representative of a method for populating a custom data mart, in accordance with an embodiment of the present invention is shown and referenced generally by numeral 300. Method 300 may be implemented using the above-described exemplary computing system environment (FIG. 1). Initially, as shown at step 310, a selection of a first table stored within a data warehouse is received. As described above, the table may be searched for by table name or description. In various embodiments, the tables comprise operational data store tables, fact tables, or a combination thereof. At step 320, a selection of at least one column is received from the first table. A selection of a second table stored within a data warehouse is received, at step 330. In one embodiment, the first table originates from a different data source than the second table. In one embodiment, the first table originates from the same data source as the second table. At step 340, a selection of at least one column for the second table is received.

Joins are created, at step 350, based on the selection of tables and columns. In one embodiment, joins may include dimension joins and custom joins. In one embodiment, creating joins includes loading all metadata associated with the selected tables and dynamically updating a schema associated with a custom data mart. The metadata, in one embodiment, includes all generated and pertinent metadata. At step 360, a custom data mart is populated with data from the selected columns. As can be appreciated, any number of columns or tables may be selected while creating the custom data mart fact table and the method 300 may be repeated as necessary until the custom data mart is populated as desired.

In one embodiment, a selection of a schedule is received from a user for populating the custom data mart. The custom data mart is populated according to the schedule. In another embodiment, a schema is created based on the selected columns. The schema is populated with data from the selected columns. In one embodiment, the data is historical data. In one embodiment, a business intelligence semantic layer is created. The business intelligence semantic layer facilitates the generation of reports. In one embodiment, a report request is received for generating a report against the custom data mart.

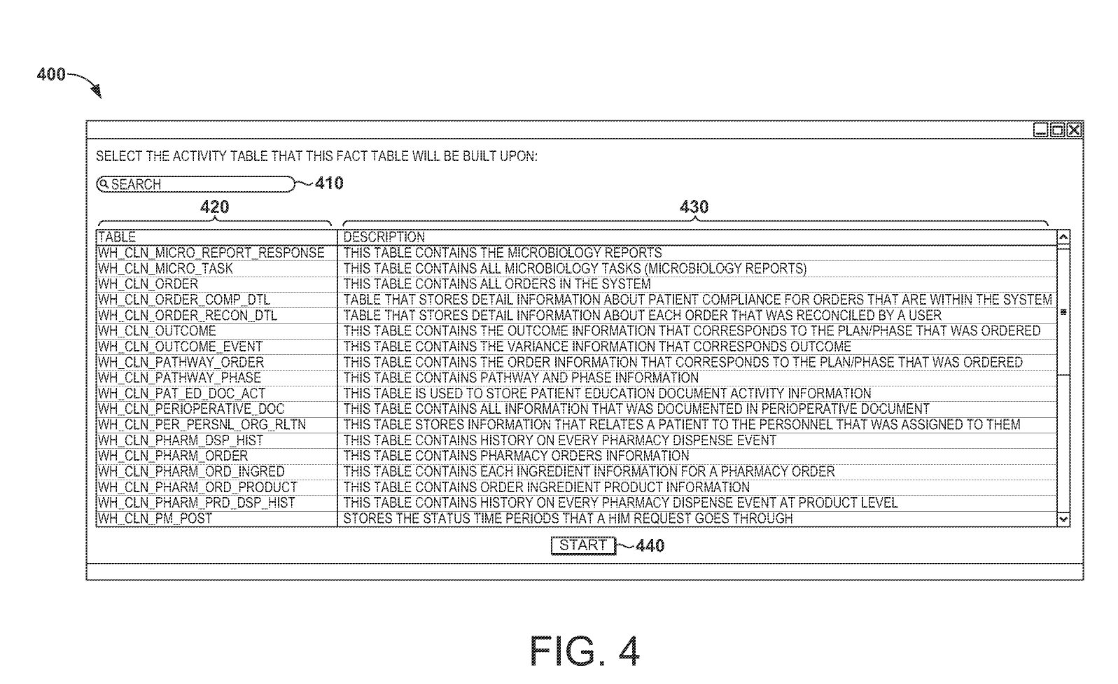

Referring now to FIG. 4, an illustrative graphical user interface 400 is shown in accordance with an embodiment of the present invention. A first display area is configured for receiving a selection of at least one table associated with health care related data stored in a data warehouse. A search area 410 allows the user to search for a table. The table may be searched for by table name, table description, or other metadata that may be associated with the table. A list of table names 420 is displayed and a desired table name may be highlighted or double-clicked. A start button 440 initiates the process on the selected table. A list of table descriptions 430 is also displayed and the desired table may be selected by its description, such as by double-clicking or highlighting and selecting start, as described above.

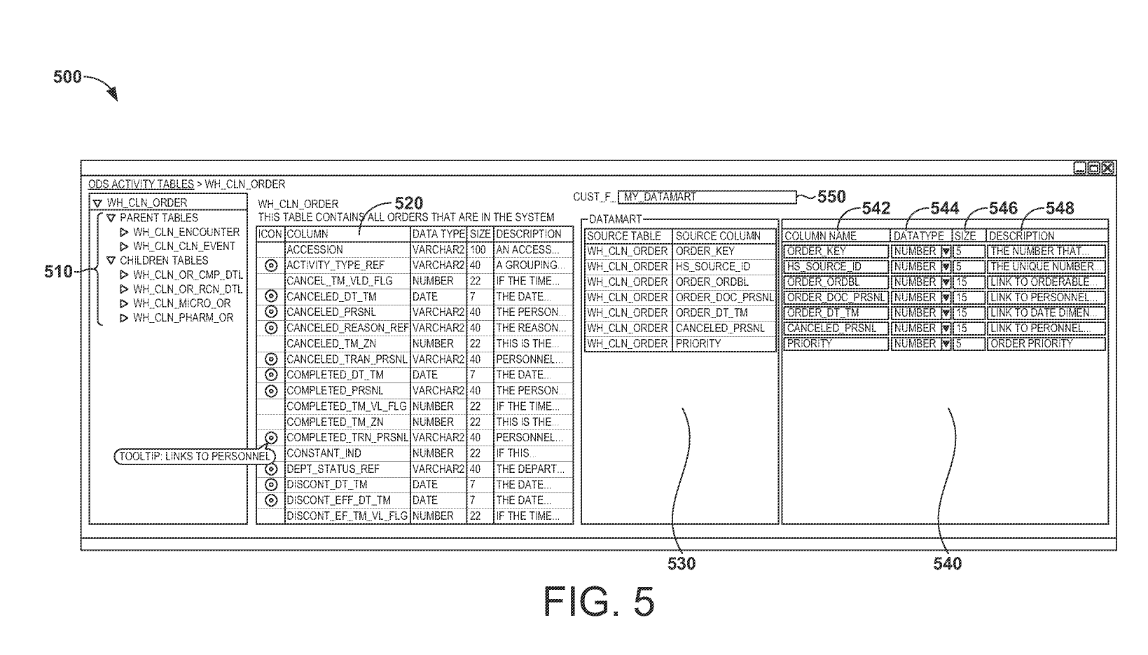

Referring now to FIG. 5, an illustrative graphical user interface 500 is shown in accordance with an embodiment of the present invention. The selected table is identified and a related table list 510 is displayed and identifies all parent and child tables. The list of related tables conveys a high-level view of table relationships and assists the user in identifying related tables for the custom data mart fact table. A list of columns associated with the selected table is displayed in a second display area 520, configured for receiving a selection of at least one column. Column attributes are displayed that assists the user in identifying the desired data for the custom data mart. In one embodiment, columns that link to dimensions have a distinctive icon. In various embodiments, the attributes include column name, data type, size, description, or a combination thereof. When the desired columns are identified, the user may drag the desired columns into a third display area 530 configured for displaying a list of selected columns associated with a custom data mart. A fourth display area 540 is configured for receiving user-defined attributes for the custom data mart. The user-defined attributes include a column name 542, a data type 544, a size 546, a description 548, and a custom data mart name 550. In one embodiment, a fifth display area (not shown) is configured for displaying the custom data mart populated with data from the selected columns.

As can be understood, the present invention provides systems, methods, and user interfaces for creating custom data marts and their respective business intelligence abstraction layer. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. Computer storage media having computer-executable instructions embodied thereon, that when executed, perform a method for facilitating the creation of custom data marts based on data stored in a data warehouse, the method comprising:
receiving a selection of a first table from a data source stored within the data warehouse;
receiving a selection of at least one column from the first table;
receiving a selection of a second table from a data source stored within the data warehouse;
receiving a selection of at least one column from the second table;
creating joins based on the selection of tables and columns; and
populating a custom data mart fact table with data from the selected columns and corresponding tables.

2. The media of claim 1, wherein joins include dimension joins and custom joins.

3. The media of claim 1, wherein the first table originates from a different data source than the second table.

4. The media of claim 1, wherein the first table originates from the same data source as the second table.

5. The media of claim 1, wherein the tables are sourced from operational data store tables, fact tables, or a combination thereof.

6. The media of claim 1, wherein creating joins includes loading all metadata associated with the selected tables and dynamically updating a schema associated with the custom data mart.

7. The media of claim 1, wherein populating a custom data mart comprises:
receiving a selection of a schedule from a user for populating a custom data mart
populating the custom data mart according to the selected schedule.

8. The media of claim 1, wherein populating a custom data mart comprises:
creating a schema based on the selected columns; and
populating the schema with data from the selected columns.

9. The media of claim 1, wherein the data is historical data.

10. The media of claim 1, further comprising creating a business intelligence semantic layer for facilitating the generation of reports.

11. The media of claim 10, further comprising receiving a report request for generating a report against the custom data mart.

12. Computer-readable media having computer-executable instructions embodied thereon that, when executed, produce a graphical user interface (GUI) for creating custom data marts, the GUI comprising:
a first display area configured for receiving a selection of at least one table associated with health care related data stored in a data warehouse;
a second display area configured for receiving a selection of at least one column stored within the at least one table;
a third display area configured for displaying a list of selected columns associated with a custom data mart; and
a fourth display area configured for receiving user-defined attributes for the custom data mart.

13. The GUI of claim 12, wherein the selected columns are selected from tables originating from separate data sources.

14. The GUI of claim 12, further comprising a fifth display area configured for displaying the custom data mart populated with data from the selected columns.

15. A computerized system for facilitating the creation of custom data marts, the system comprising:
at least one device transmitting health care related data to a server comprising at least one component;
a table selection component for receiving a selection of a table associated with the health care related data stored in a data warehouse;
a column selection component for receiving a selection of a column associated with the selected table;
a join component for creating joins based on the selection of tables and columns; and
a population component for populating the custom data mart with data from the selected columns.

16. The system of claim 15, further comprising a scheduling component for scheduling the population of the custom data mart with data from the selected columns.

17. The system of claim 15, further comprising a schema component for creating a schema based on the selected columns, wherein the schema is populated by the population component.

18. The system of claim 15, further comprising a business intelligence component for creating an abstraction layer for facilitating the generation of reports.

19. The system of claim 18, further comprising a reporting component for generating reports of the custom data mart facilitated by the abstraction layer.

20. The system of claim 15, wherein the data is historical data.
